(19) United States
(12) Patent Application Publication
(10) Pub. No.: US 2026/0091628 A1
(43) Pub. Date: Apr. 2, 2026

(54) TRAILER BREAKAWAY LANYARD FOR USE ON A TOW VEHICLE

(71) Applicant: Davis Village Solutions, LLC, Baraga, MI (US)

(72) Inventors: Niel S. Somero, New Ipswich, NH (US); David M. Somero, New Ipswich, NH (US); Matthew J. Somero, Rindge, NH (US); Nathan K. Somero, New Ipswich, NH (US)

(21) Appl. No.: 19/346,663

(22) Filed: Oct. 1, 2025

Related U.S. Application Data
(60) Provisional application No. 63/702,176, filed on Oct. 2, 2024.

(51) Int. Cl. B60D 1/58

(52) U.S. Cl. CPC B60D 1/58

(57) ABSTRACT

A breakaway lanyard for a vehicular trailer hitch assembly includes a flexible cable having (i) a first end having a first loop (ii) a second end opposite the first end and having a second loop and (iii) an elongated portion extending between the first end and the second end. The flexible cable is configured to wrap around a structural member of a vehicle with the first loop coupling to the elongated portion to attach the breakaway lanyard to the vehicle. With the breakaway lanyard attached to the structural member of the vehicle, and with a trailer coupled to a hitch of the vehicle, and with the second loop coupled to the breakaway cable of the trailer, movement of the breakaway cable away from the structural member of the vehicle causes tension in the flexible cable and the breakaway cable to activate an emergency braking system of the trailer.

### CROSS REFERENCE TO RELATED APPLICATION

The present application claims the filing benefits of U.S. provisional application Ser. No. 63/702,176, filed Oct. 2, 2024, which is hereby incorporated herein by reference in its entirety.

### FIELD OF THE INVENTION

The present invention relates generally to the field of trailer systems for utility trailers and towing vehicles.

### BACKGROUND OF THE INVENTION

In many instances, a large and/or heavy trailer, in combination with a tow vehicle, includes an independent and fail-safe trailer breakaway wheel braking system. The trailer breakaway braking system is commonly configured to quickly and safely bring the trailer to a complete stop within a generally specified distance of travel in the event of unintended detachment of the trailer at a trailer hitch drawbar device or otherwise a complete breakaway from the tow vehicle due to mechanical failure of a trailer hitch, tow vehicle chassis and/or the trailer hitch drawbar device, or other related components. In other words, the trailer breakaway braking system activates trailer brakes of the trailer to quickly bring the trailer, including any cargo carried by the trailer, to a rapid, safe, and complete stop after the trailer detaches from the tow vehicle.

Many trailer breakaway wheel braking systems are designed to operate automatically with no sudden immediate direct input from the driver of the tow vehicle in the event of any sudden and/or unexpected detachment or breakaway of the trailer from the tow vehicle. Once the trailer does come to a complete stop after breaking away from the tow vehicle, the trailer brakes may remain engaged or active for a specified period of time, or otherwise indefinitely, until the trailer brakes can be manually released and the trailer, including any cargo carried by the trailer, can then once again be safely moved.

In the United States, and many other countries, it is a legal requirement for the trailer and the tow vehicle to include the trailer breakaway wheel braking system if the trailer and the tow vehicle exceed a specified threshold load capacity and/or size. The specified threshold load capacity and size for the trailer and the tow vehicle to require the trailer breakaway wheel braking system may vary depending on the jurisdiction. Traffic citations and fines may be issued when the tow vehicle and the trailer are connected to one another in a manner that is inadequate or otherwise or improperly configured. Frequently, drivers of tow vehicles and trailers are randomly subjected to Department of Transportation (DOT) inspections and may suddenly and often surprisingly discover that a trailer breakaway activation cable of the trailer breakaway wheel braking system is incorrectly configured or otherwise improperly attached to an incorrect location at or onto or near the trailer hitch of the tow vehicle. The trailer breakaway activation cable that is improperly attached at the trailer hitch of the tow vehicle may not only violate a statute, but may also render the trailer breakaway wheel braking system non-functional.

Tow vehicles and trailers equipped with proper trailer breakaway cable breaking systems that are not regulated by the DOT or are not associated for use on public roadways and areas, may still pose safety risks if the tow vehicle and the trailer include the trailer breakaway wheel braking system with the trailer breakaway activation cable improperly attached. For example, tow vehicles and trailers involving use in or at farmlands, wilderness areas, construction zones, material storage facilities, mining operations, and airports, etc., may implement the trailer breakaway wheel braking system. Such non-public roadways and work areas can also typically benefit from and include vehicles that tow heavy trailers having electrically activated braking systems further including an on-board trailer battery or power source to automatically energize and activate trailer braking systems during any instances of a breakaway trailer occurrence or accident. In the event that the trailer that is being towed behind the tow vehicle, wherein the trailer is substantially heavy or large, suddenly breaks away from the tow vehicle for any reason, and proper control of the trailer is suddenly, unexpectedly, and entirely lost, it is essential to ensure that both vehicle operating personnel and general public safety is maintained. In the event of a runaway trailer, it must be brought to a safe stop as quickly and as automatically as possible. This is necessary to largely help reduce and avoid the likelihood of serious accidents occurring, which can additionally and easily lead to and further include excessive and possible resulting property damage, and/or injury, or perhaps possible death to other vehicle operators or otherwise anyone in proximity to such an accidental and rapid accidental breakaway trailer occurrence.

The safety benefits associated with the runaway trailer coming to a rapid and controlled stop as quickly and effectively as possible apply regardless of whether the tow vehicle and the trailer are legally required to implement the trailer breakaway wheel braking system. While heavy trailers and cargo loads represent a higher level of potential danger if the trailer detaches from the tow vehicle, light weight trailers and cargo loads are typically exempt from having or requiring operable DOT-approved trailer breakaway wheel braking systems, or some other form of automatically-activated failsafe trailer braking system.

The legal requirements for heavier tow vehicle and trailers to implement the trailer breakaway wheel braking systems are determined by several different factors, however, gross vehicle weights are typically the predominant variables and determinants. Within the United States, state and federal DOT guidelines and regulations may somewhat vary between states and between certain geographic areas and/or legal jurisdictions.

Regardless of specific areas and their respective DOT requirements, once the total gross weight of a given tow vehicle and/or trailer weight exceeds a specified threshold, a breakaway trailer wheel braking system is typically required. Proper implementation, control, and activation of the breakaway trailer wheel braking system is essential toward ensuring the best possible safety practices within the interests and aspects of safe public transportation.

### SUMMARY OF THE INVENTION

A breakaway lanyard for a vehicular trailer hitch assembly includes a flexible cable (or other flexible wire or body or element made of a generally flexible and highly durable material) having a first end and a second end. For example, stainless steel cable is one such material due to its relative excellent strength and resistance to corrosion from the elements of weather, road salt, and the effects of extreme temperatures. Other materials such as nylon, carbon fiber, and various similar materials may also provide acceptable service life. A first loop may be formed at the first end and a second loop may be formed at the opposite second end, such as by folding the elongated portion on itself and crimping the first end and the second end to the flexible cable. The lanyard is configured to wrap around a structural member of a vehicle with the elongated portion passing through the first loop to attach the breakaway lanyard to the vehicle. With the breakaway lanyard attached to the vehicle, and with a trailer coupled to a hitch of the vehicle, the second loop is configured to couple to a breakaway cable of the trailer. Thus, with the second loop coupled to the breakaway cable of the trailer, movement of the breakaway cable away from the structural member of the vehicle causes tension in the breakaway lanyard and the breakaway cable to activate an emergency braking system of the trailer.

Optionally, at least one of a durable information or instruction tag is permanently affixed to one of the two closed or looped ends of the lanyard. A user information tag, also comprised of preferably highly durable material, further includes at least one or more instructions, information, or otherwise an illustrative reminder to the user for the proper installation, use, and configuration of the elongated lanyard onto and between the tow vehicle and the coupled or hitched trailer.

These and other objects, advantages, purposes and features of the present invention will become apparent upon review of the following specification in conjunction with the drawings.

### BRIEF DESCRIPTION OF THE DRAWINGS

FIG. 1 is a perspective view of a tow vehicle, a trailer, and a trailer hitch assembly including a trailer breakaway lanyard;

FIG. 1A is an enlarged view of Area A in FIG. 1, showing the trailer breakaway lanyard;

FIG. 1B is an enlarged view of Area B in FIG. 1B, showing the trailer breakaway lanyard looped through a non-towing hitch structural member of the tow vehicle;

FIG. 2 is a perspective view of the trailer breakaway lanyard;

FIG. 3 is a side view of the trailer breakaway lanyard;

FIG. 4 is a top view of the trailer breakaway lanyard;

FIG. 5 is front view of the trailer breakaway lanyard;

FIG. 5A is an enlarged view of Area A in FIG. 5, showing a warning tag securely affixed to the trailer breakaway lanyard;

FIG. 6 is a partial perspective view of the tow vehicle and another example trailer breakaway lanyard;

FIG. 6A is an enlarged view of Area A in FIG. 6;

FIG. 7 is a partial perspective view of the tow vehicle and another example trailer breakaway lanyard;

FIG. 7A is an enlarged view of Area A in FIG. 7; and

FIG. 8 is an exploded view of an lanyard cable clamp of the trailer breakaway lanyard of FIG. 7.

### DESCRIPTION OF THE PREFERRED EMBODIMENTS

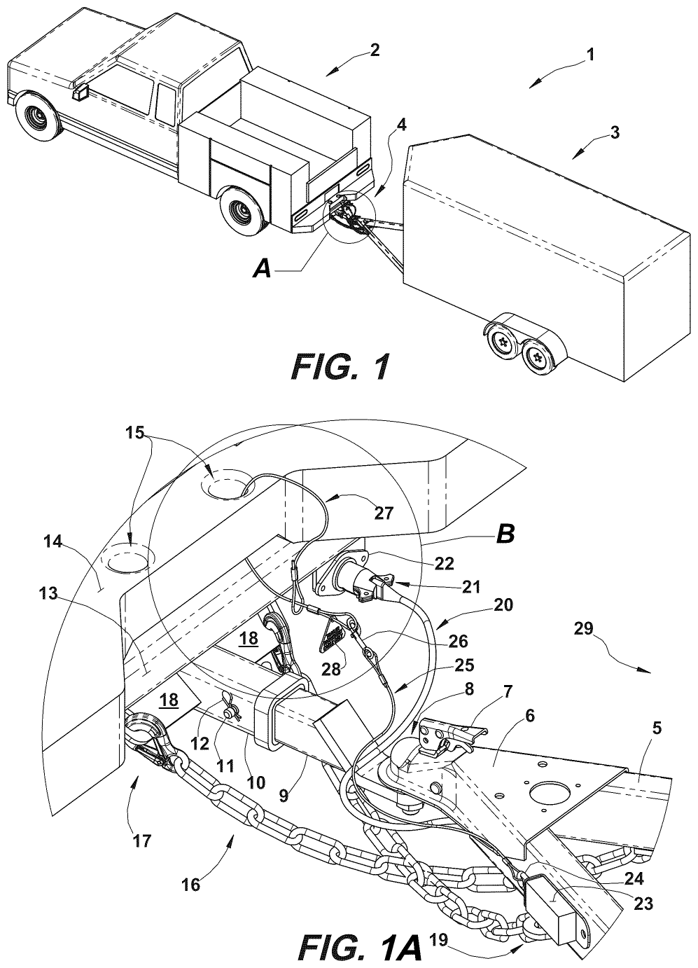

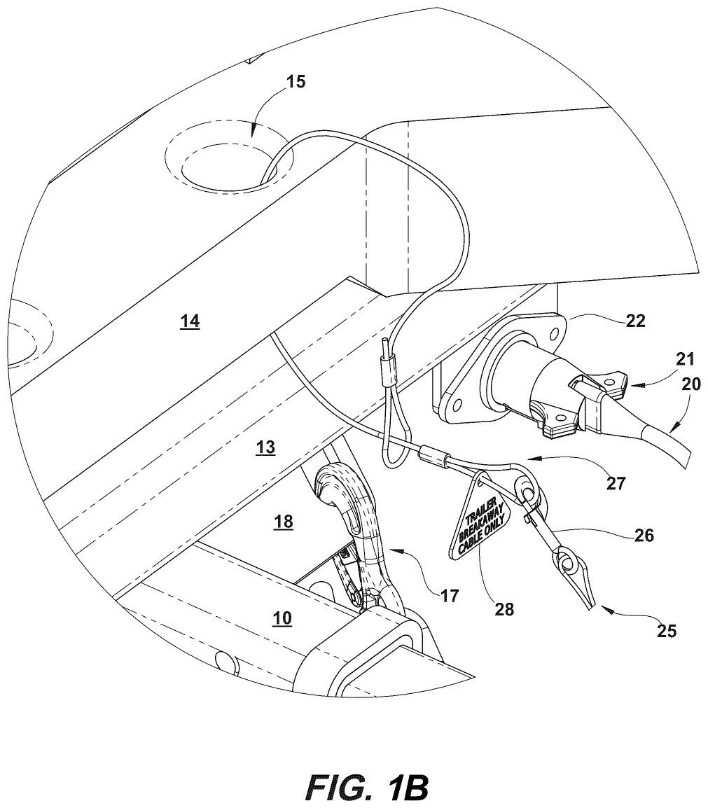

Referring to the drawings and the illustrative embodiments depicted herein, and with specific reference to FIG. 1, a tow vehicle and trailer arrangement 1 may include towing vehicle or a tow vehicle 2 (e.g. a work truck wherein the pick-up cargo box has been replaced by a service body containing storage compartments), and a trailer 3, wherein the tow vehicle 2 and the trailer 3 are securely connected by a trailer hitch assembly 4 involving a number of typical components for the purpose of safely pulling and towing the trailer 3 by means of the tow vehicle 2. The tow vehicle 2 may comprise a typical building trades or other services work truck tow vehicle configured with the towing hitch 4 and related components for towing the single axle trailer 3. In this case, the trailer 3 includes an enclosed trailer for transporting various cargo and materials over public roadways and highways and the towing hitch 4 is configured per applicable public roadways and jurisdiction legal safety requirements for preferred fail-safe operation of both the tow vehicle 2 and utility trailer 3 over public transportation roadways.

With reference to FIG. 1A, the trailer hitch assembly 4 includes a forward end of a trailer tongue frame 5. The forward end of the trailer tongue frame 5 includes a trailer hitch ball coupling 6 equipped with a movable locking handle 7. The trailer hitch ball coupling 6 is seated and rests upon a trailer hitch ball 8 (not entirely shown as it is hidden by the trailer hitch coupling 6). In FIG. 1A, the movable locking handle 7 is lowered and locked into place to secure mechanical attachment and free pivotal movement of the trailer 3 relative to the tow vehicle 2. This mechanical joint attachment provides vertical mechanical support for a front portion of the trailer 3 while further allowing free pivotal relative movement and positive engagement between the trailer 3 and the tow vehicle 2 during roadway travel and vehicle maneuvering. The trailer hitch ball 8 is affixed to a trailer hitch drawbar 9. The trailer hitch drawbar 9 is slidably engaged into a trailer hitch receiver tube 10 and held into position by a hitch pin 11 and is further held into position by a hitch pin cotter pin 12. The trailer hitch receiver tube 10 is welded to a mounting member 13 of the trailer hitch assembly 4. The mounting member 13 is securely fastened and attached to a chassis of the tow vehicle 2 via, for example, fasteners, attachment points, and methods of attachment to the chassis not shown in the illustrative examples.

A tow vehicle bumper 14 is attached to the tow vehicle 2 and may be a separate component with respect to the mounting member 13. For example, a pair of vehicle bumper through-holes 15 are provided to illustrate the use and implementation of the trailer breakaway lanyard. A pair of trailer hitch safety chains 16 including a pair of safety chain hooks 17 are hooked onto and engaged with openings within one or more trailer hitch safety hook plates 18. The one or more trailer hitch safely hook plates 18 are welded onto the mounting member 13 and are a permanent part of its supporting structure. The rearmost ends of the pair of trailer hitch safety chains 16 are securely attached to the trailer tongue frame 5 by either a bolted joint fastener (not shown) or by a respective link of each of the pair of trailer hitch safety chains 16 securely welded directly onto the trailer tongue frame (not shown).

A trailer electrical harness 20 includes a trailer electrical harness plug 21 that is inserted into a trailer electrical harness socket 22 which is mounted onto the tow vehicle 2, thus providing electrical power from the tow vehicle 2 to the trailer 3, such as for lighting, turn signals, brake lights, and normal energization of electrically activated wheel brakes at the trailer 3 by a brake controller within the tow vehicle 2 (system components not shown).

A trailer breakaway activation switch 23 is affixed to the trailer tongue frame 5 and includes an activation key 24 such that whenever the activation key 24 is pulled by means of tension of a trailer breakaway cable 25 in the event of the occurrence of a breakaway trailer event, a set of electrical contacts within the breakaway activation switch 23 automatically and physically close under spring tension to readily engage to a closed position to energize and activate the electrical wheel brakes of the trailer 3 via an onboard trailer breakaway electrical storage battery 29.

A proper attachment point for the trailer breakaway activation cable includes attachment at or onto a frame or chassis of the tow vehicle, an original equipment chassis member of the tow vehicle, or otherwise a sturdy structural original equipment component of the tow vehicle (such as for example, a non-tow hitch vehicle frame member or bumper) that is separate from a supporting structure of the tow hitch. The essential problem with properly attaching the trailer breakaway activation cable to the tow vehicle is that this level of important detail tends to be less-than-obvious for at least some, if not numerous, tow vehicle drivers, operators, and owners. Alleviating and correcting this somewhat common and less than obvious matter and misunderstanding associated with improper attachment of the trailer breakaway activation cable is advantageous. Thus, it is desired to provide a device and method of installation for an ease-of-use and repeatable standard toward more consistent and improved overall transportation safety involving tow vehicles and trailers in excess of a specified threshold load capacity and/or size that must meet the requirements of having the trailer breakaway cable properly attached to the correct location point at the tow vehicle.

With reference to FIGS. 1B-5A, a trailer breakaway lanyard 27 is arranged for attachment through and around by example the tow vehicle bumper 14 and the trailer breakaway cable 25 at an attachment hook 26. The attachment hook 26 is configured to provide convenience while both detaching or re-attaching the trailer to the tow vehicle and provides for ease of detachment of the lanyard 27 from the trailer breakaway cable 25 whenever the trailer is detached from the tow vehicle 2. The trailer breakaway lanyard 27 may remain preferably installed and safely secured by the user on and with the tow vehicle bumper 14 when not in use, yet remain ready for later user and trailer towing by a user and further serve as a consistent and correct trailer breakaway use and towing safety reminder and further serves as an easily identifiable and easy-to-use connection point for the trailer breakaway cable 25 whenever the next user should attach a trailer 3 to the tow vehicle 2. FIG. 1B shows an example of the practical installation and functional application and use of the trailer breakaway lanyard connection device 27 as it is looped through a non-towing hitch structural member of the tow vehicle 2. In this case, the lanyard 27 is attached to the tow vehicle's rear bumper 14, which is not a directly loaded or otherwise mechanically stressed component or portion thereof of the tow vehicle's tow hitch assembly during trailer towing operation.

This aspect is helpful and important for multiple driver-operators and operations within companies involving multiple fleet vehicles and multiple fleet trailers used daily at various times and in various combinations. The aspect of consistent visual communication that the trailer breakaway lanyard assembly can provide provides a significant improvement in consistency, and therefore an important improvement toward safety, involving potentially various multiple driver-operators, trailers and tow vehicles, thus reducing the likelihood of potential runaway trailer issues and the potential for possible accidents that could result from simple oversight, carelessness, or lack of proper trailer and tow vehicle safety awareness and communication of proper use.

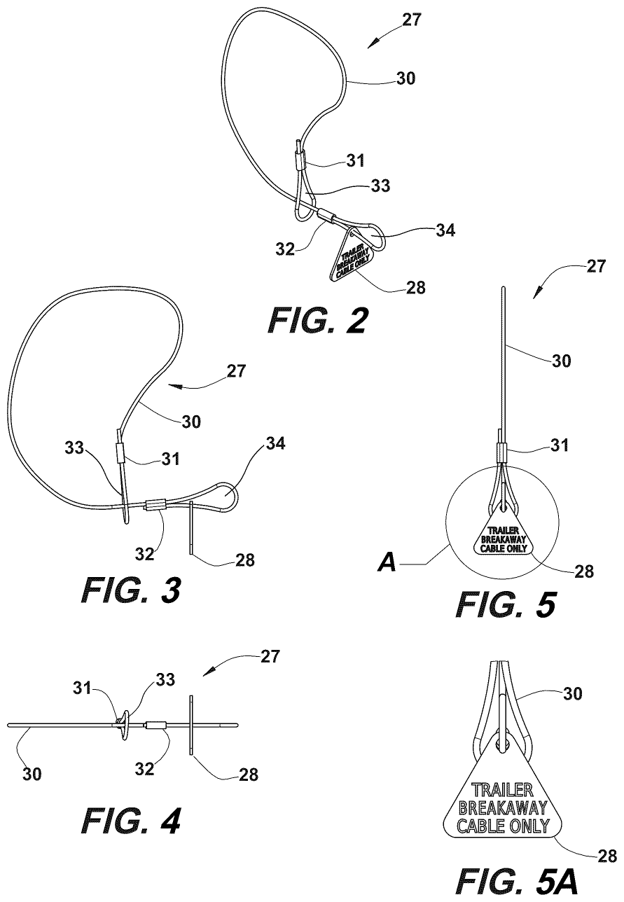

Referring to FIGS. 2-5A, the trailer breakaway lanyard 27 includes a cable (or wire or element or body) 30 that is comprised of flexible and durable material selected to be of sufficient material strength and durability to properly and reliably function correctly over years of exposure to the outdoor elements, and under conditions of mechanical stress when and should it become necessary for the trailer hitch assembly 4 to correctly perform as intended. For example, in the embodiment shown, the cable 30 of the trailer breakaway lanyard 27 is formed from corrosion resistant multistranded, nominally flexible steel or otherwise preferably stainless steel. Optionally, the trailer breakaway lanyard 27 may be further coated with a flexible urethane plastic coating to reduce the likelihood of damaging the surface finishes of painted or plated surfaces of the tow vehicle 2 (e.g., the bumper 14). Further optionally, the trailer breakaway lanyard 27 may include a high-strength strap material such as nylon, Kevlar, flexible carbon fiber or other similar materials in either generally round, flat or other basic geometrically shaped material cross-sections as preferred for ideal product performance, durability, low cost, and/or ease-of-manufacturing.

A pair of distal ends of the trailer breakaway lanyard 27 are configured into a first closed loop 33 and a second closed loop 34 with the pair of distal ends of the trailer breakaway lanyard 27 affixed or otherwise crimped to the cable 30 via a first compression fitting 31 and a second compression fitting 32. The first and second compression fittings 31, 32 may comprise a corrosion resistant material such as aluminum. In other words, the lanyard 27 folds back onto itself, thus forming the two closed loops, with a single loop of lanyard material being formed at each of the two ends. Additionally, a durable information or instruction tag 28 is permanently affixed to at least one of the closed loops 33, 34.

In the illustrated example, the information tag 28 is affixed to the second closed loop 34. The information tag 28 further includes at least one message (e.g., an instruction or information) or otherwise an illustrative reminder to the user for the proper installation, use and configuration of the lanyard onto the tow vehicle. Further, the information tag 28 may be formed from sheet aluminum including an anodized protective coating for further corrosion resistance and durability, further providing a selected color (red for example) for high contrast with computer aided machining (CAM) of instructional words, lettering or identification symbols for ease of manufacturing permanent relief-embossed lettering on the front and back surfaces of the tag. Optionally, the information tag 28 may be molded of durable plastic including embossed lettering or instructions as might be preferred.

The installation and use of the trailer breakaway lanyard 27 is such that the cable 30 is looped around and secured onto a sufficiently secure structural component of the tow vehicle 2 such as, for example, the tow vehicle bumper 14 (if separate from the structure of the tow hitch) or a frame of the tow vehicle 2, and not directly affixed to any of the trailer hitch drawbar 9 or any hitch components of the tow vehicle 2. That is, one end of the lanyard is looped around and secured onto a sufficiently secure structural component of the tow vehicle itself and not directly affixed to any of the actual tow vehicle drawbar components or tow vehicle hitch components.

A reason for this is that it is not always obvious to all tow vehicle drivers and operators that the “forward free end” of the trailer breakaway cable 25, which is directly attached to the trailer breakaway activation switch 23 on the trailer 3, must be also be securely attached (at its forward free end) to a “secure non-tow hitch vehicle component” (according to typical DOT requirements). In other words, the forward end of the trailer breakaway cable 25 must be securely attached to, or otherwise affixed to, a frame structure of the tow vehicle 2 itself, and not any part or portion thereof of the tow vehicle's 2 trailer hitch or its associated components. Put another way, the forward end of the lanyard 27 must be attached directly to only the tow vehicle 2 itself. In this case, in the event that the entire tow hitch assembly 4 (along with the trailer 3) becomes completely separated from the tow vehicle 2, the lanyard 27 must always be correctly installed to fully and automatically activate the breakaway trailer safety switch, and brakes on the trailer 3 itself, in order to properly trigger and activate the trailer braking system (in remote fashion) if such a complete and catastrophic separation between the tow vehicle 2 and the entire trailer 3 (including the trailer hitch of the tow vehicle) should somehow occur.

According to a possible first trailer hitch failure mode example, in any instance where the trailer hitch ball 8, for example, is somehow not properly set or engaged, secured, or otherwise not properly and fully locked onto the trailer hitch ball coupling 6 of the tow vehicle 2, the trailer hitch ball coupling 6 can suddenly and unexpectedly become detached from the tow vehicle 2. In such instances, the pair of trailer hitch safety chains 16 connected between the tow vehicle 2 and trailer 3 are designed and intended to preferably prevent the trailer 3 from completely separating from the tow vehicle 2. In the event of this kind of undesirable hitch detachment, the pair of trailer hitch safety chains 16, if properly set and correctly adjusted in a crisscross pattern just below and under the trailer hitch coupling 6 (FIG. 1A), can alleviate complete loss of control of the trailer and the tow vehicle and can by design provide an effective and temporary “cradled support” (although a potentially loose and somewhat unstable support) of the trailer hitch coupling 6 and the forwardmost portion, or end, of the trailer 3. Such temporary support can be provided at the front of the trailer at least until the vehicle operator can bring the tow vehicle 2 and trailer 3 to a rather urgent and safe emergency stop at the side of the road for inspection of the cause and corrective action without further harm or damage to vehicles or property. With this possible type of partial trailer hitch malfunction and resulting partial detachment of the trailer 3 from the tow vehicle 2, it remains uncertain in all cases, whether or not the breakaway activation switch 23 would be at all activated by any sufficient tension force generated, upon partial separation of the trailer, within the given length of the trailer breakaway cable 25 itself because of relative free movement between the trailer 3 and the tow vehicle 2.

Generally, the level of sufficient tension force generated within the trailer breakaway cable 25 to properly engage or activate the trailer's 3 breakaway activation switch 23 may vary between switch manufacturers. Such variable factors may include for example, the given effective length of the trailer breakaway cable 25 between the connection point locations of the trailer breakaway cable 25 at the tow vehicle and at the trailer, the routing path between the tow vehicle 2 and trailer 3 in proximity to the hitch receiver tube 10, and degree of dynamic movement or deflection that may or may not occur at the hitch receiver tube 10 itself as a detachment event may occur. With so many potential dimensional variables involved which could potentially further affect proper safety while towing a trailer, it is advantageous to further provide a means to easily and readily adjust and preferably remove any excess length within the trailer breakaway lanyard cable, as it is installed by a user between the tow vehicle and trailer in each given instance.

According to another possible and more catastrophic trailer hitch failure mode example, it is possible that a much more severe trailer hitch malfunction could possibly occur. In this case, causing a sudden and complete separation of the trailer 3 from the tow vehicle 2 including the trailer hitch assembly 4 would entail mechanical separation of the entire trailer hitch assembly 4 from the structural frame of the tow vehicle 2 itself. This may include separation of the specific points of mechanical attachment of the trailer 3 at the chassis of the tow vehicle 2, including the pair of safety chains 16 and their respective attachment points, all electrical harness connections to the trailer (including trailer wheel braking controls), and the trailer 3 itself, thus causing and involving a complete loss and control of the trailer 3, further including any cargo, as the trailer 3 continues to travel in its given direction of motion down the roadway.

Alternatively, whenever the tow vehicle 2 and the trailer 3 are stopped or parked, for example, on a hill, slope, or incline grade, and a complete separation of the tailer 3 from the tow vehicle 2 should somehow occur, a completely separated trailer, including its potential cargo, could begin to roll and continue to be free-to-roll, in either the forward direction, thus likely striking the tow vehicle 2, or otherwise roll rearward and out of control indefinitely. Such a complete and catastrophic trailer detachment failure could be caused by or become due to any number of unforeseen circumstances or reasons. Reasons include for example, inadequately secured or tightened fasteners, improper strength fasteners, excess metal stress or fatigue, metal corrosion (severe rust) over an extended period of time, or for some as of yet unknown or unexpected reason, where the entire trailer hitch assembly 4 becomes entirely and suddenly detached from the frame of the tow vehicle 2 itself.

With respect to the trailer breakaway lanyard 27 and its proper use, during a total and catastrophic separation of the tow vehicle 2 and trailer 3 while traveling at speed on a roadway, a properly installed and configured trailer breakaway cable 25 between the tow vehicle 2 and trailer 3 can serve to help minimize and preferably entirely avoid as much as practically possible, a potentially catastrophic resulting accident, property damage, injury or loss of life, and/or negative outcome of such an unfortunate and unexpected incident.

Additionally, and ideally in all cases where it is required by state and/or federal highway vehicle regulations, the breakaway activation switch 23 at and on the trailer 3 will be successfully activated (turned on) by excess tension of and within the trailer breakaway cable 25, between the tow vehicle 2 and the trailer 3 upon complete (or perhaps even partial) separation of the trailer 3 from the tow vehicle 2. This is provided that the mechanical communication connection of the trailer breakaway cable 25 is in fact correctly attached to both the structure of the tow vehicle 2 and the trailer's breakaway activation switch 23 that automatically engages and activates the trailer's on-board electrical brake system. As such, a correctly configured trailer towing connection and system serves to electrically activate electrical power from the trailer's on-board battery power supply and engage the trailer's electrically activated brakes to immediately slow and preferably quickly and safely stop the free and uncontrolled trailer including its cargo. Thus, such an extreme, mostly unforeseen, and yet possible runaway trailer accidentally incident can be largely minimized as much as practically possible and hopefully avoided, by slowing and stopping the detached trailer 3 from continuing to roll (in either forward or backward directions), once it has rapidly arrived at a full stop.

During this particular and catastrophic mode of trailer hitch failure, an automatic trailer stoppage will not likely be successful as intended by design, if the forward end of the trailer breakaway cable 25 is inadvertently (or otherwise unknowingly by the user), incorrectly mechanically connected to any component portion of the trailer hitch assembly 4 of the vehicle 2, should that specific attachment point be included with the detached and departing trailer 3 as it separates from the tow vehicle 2. In this case, the breakaway activation switch 23 will not be engaged, and the trailer's 3 electric brakes will not become properly and automatically activated as correctly intended by design and department of transportation (DOT) requirements. Therefore, it is essential, and yet not entirely obvious to driver-operators who are in the process of configuring and setting up the tow vehicle 2 to pull the trailer 3, that the forward end of the trailer breakaway cable 25 must be properly attached to only the tow vehicle 2 itself and not, for example, the hitch receiver tube 10. In other words, the trailer breakaway cable 25 must always be attached to a portion of the tow vehicle 2 itself, that is separate from the hitch assembly 4 at the tow vehicle 2.

For example, and as shown in the drawings, the trailer breakaway lanyard 27 is provided to be readily installed and looped around, secured, and correctly attached to a “non-tow hitch” structural member of the tow vehicle 2, such as for example, the vehicle bumper 14. The trailer breakaway lanyard 27 thus provides a correct, consistent, and easily identifiable point of mechanical connection for the trailer breakaway cable 25 connection.

The usefulness of the trailer breakaway lanyard 27 and the information tag 28 is to not only promote vehicle safety by reminding tow vehicle drivers and trailer operators of the correct and proper attachment point for use of the trailer breakaway cable 25, but additionally provide a correct, easy-to-readily-identify, consistent, and easily repeatable and durable connection point for the trailer breakaway cable 25 to be attached and affixed to at the rear portion of the tow vehicle 2. Additionally, the trailer breakaway lanyard 27 and the information tag 28 can remain either temporarily or permanently, yet securely, mechanically looped onto, around, and attached to the tow vehicle 2 (a non-hitch bumper for example) when not in use. As such, the trailer breakaway lanyard 27 can optionally remain in place as a user reminder for continued or immediate re-use, with or without the continued presence of the trailer 3 being attached to the tow vehicle 2 (which may be beneficial for tow vehicles within a fleet of tow vehicles).

Another advantage of the trailer breakaway lanyard 27 is presented within company vehicle fleet applications involving, for example, any number of different tow vehicles along with various numbers and/or types of trailers and combinations of towable equipment. Various trailers may likely be intermittently used by, for example, a construction contractor or other service provider business on a regular daily basis and where combinations of different drivers and users of tow vehicles and including different trailers are interchanged on a regular typical basis. The lanyard 27, such as the second closed loop 34 of the trailer breakaway lanyard 27, is clearly identified as the trailer breakaway cable 25 attachment point and can provide increased ease-of-use efficiency, improved consistency, and an improved measure of safety toward avoiding the potential for vehicle incidents and accidents within any business organization throughout its daily fleet operations. Such improvements toward vehicle fleet safety consciousness and active improvement can provide additional benefits extending toward demonstrated proactive safety policies within a company or organization, fewer potential vehicle related accidents involving towed trailers and tow vehicles, potential insurance claims, and increased insurance premium costs long term.

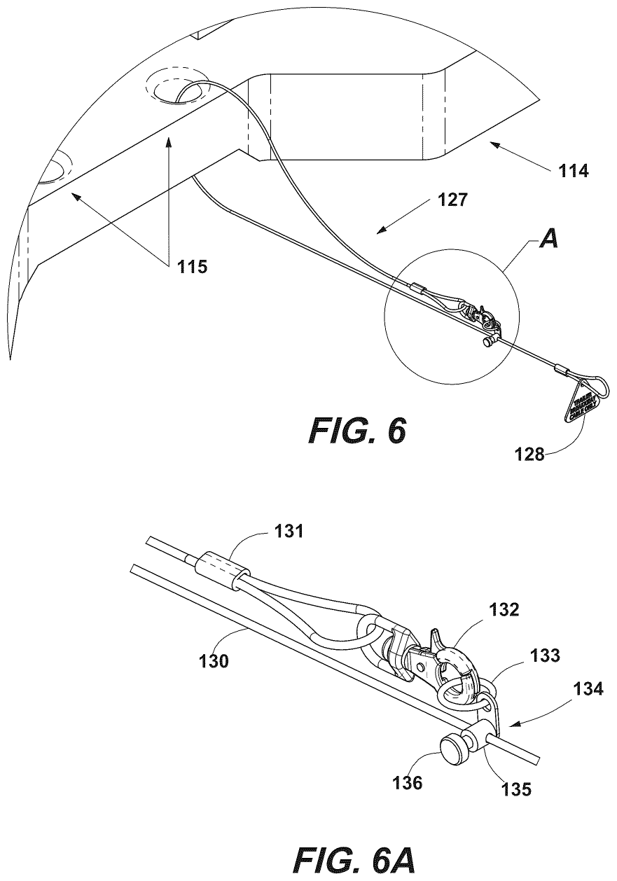

FIGS. 6 and 6A show another example of an adjustable length breakaway lanyard device 127 having a trailer breakaway lanyard identification tag 128 and further including lanyard cable 130, a lanyard cable compression crimp 131, a hook with swivel eye 132 (e.g., commercially available as part number 3919T256 from McMaster-Carr Supply Company of Elmhurst, IL), a stainless steel split ring 133 (e.g., commercially available as part number 90905A653 from McMaster-Carr Supply Company of Elmhurst, IL), a copper set screw lug 134 (e.g., commercially available as part number 6923K61 from McMaster-Carr Supply Company of Elmhurst, IL), and a knurled-head thumb screw 136 (e.g., commercially available as part number 91746A696 from McMaster-Carr Supply Company of Elmhurst, IL).

FIG. 6A shows a close-up view and arrangement of the components shown in FIG. 6, whereby the hook with swivel eye 132 can be either attached to and engaged with split key ring 133 during trailer connection and towing, or otherwise detached for ease-of-use and physical routing of the adjustable length trailer breakaway lanyard assembly 127 for correct physical engagement through a non-tow hitch component of the trailer towing vehicle. In FIG. 6, engagement with the adjustable length lanyard 127 is provided by example of use of either one of the vehicle bumper through-holes 115.

To couple the first loop of the lanyard 127 to the elongated portion of the lanyard 127, the elongated portion of the lanyard 127 passes through a first passageway of the set screw lug 135 of the set screw lug assembly 134 and the set screw 136 is threadably received along a threaded second passageway of the set screw lug 135. The second passageway extends transverse to the first passageway (e.g., at a right or substantially 90 degree angle) and is in communication with the first passageway. Thus, the set screw 136 engages the lanyard 127 within the first passageway when tightened. The hook with swivel eye 132 and split key ring 133 couple between the first loop and the set screw lug 135.

Length adjustment of the adjustable trailer breakaway lanyard assembly 127 is accomplished by partial loosening of the knurled-head thumb screw 136 and then sliding the screw lug assembly 134 along lanyard cable 130 in either direction along the lanyard cable 130 to achieve the desired amount of cable slack or general tightness within the trailer breakaway lanyard assembly 127 as it is connected and is then engaged between the tow vehicle bumper 114 and the trailer breakaway cable leading to the trailer breakaway activation switch.

That is, hardware components are used and assembled to provide a detachable hook end for the lanyard with a swivel end as such detachment can provide for ease of routing the lanyard through opening within a tow vehicle's bumper, frame, or chassis member as may be needed. A corrosion resistant sliding cable clamp further provides for ease of lanyard length adjustments in any given installation application between trailers and tow vehicles, further including a threaded thumbscrew at the sliding cable clamp mechanism that further allows for ease of adjustment and securement by hand without the need for tools.

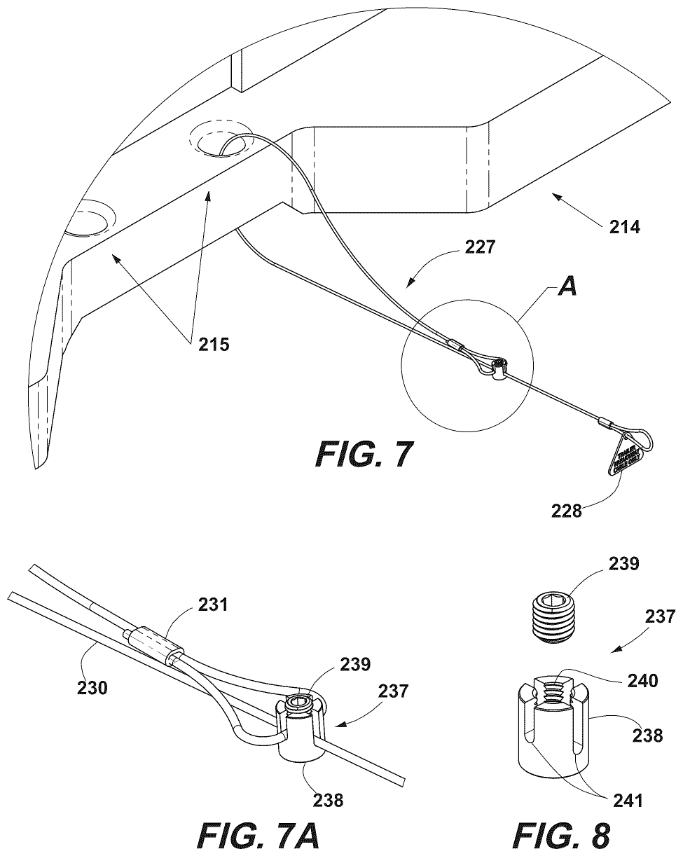

FIGS. 7 and 7A show another example of an adjustable length breakaway lanyard device 227 assembled for use using a cable clamp lug assembly 237. This embodiment provides for another simplified adjustable length lanyard having fewer components. The cable clamp lug assembly includes a cable clamp lug 238 and a cable clamp set screw 239. Threaded engagement of these two components provides length adjustment of the adjustable length trailer breakaway lanyard assembly 227.

To couple the first loop of the lanyard 227 to the elongated portion of the lanyard 227, the elongated portion of the lanyard 227 passes through a first passageway of the cable clamp lug 238, and the first loop is received within a second passageway of the cable clamp lug 238. The first passageway and the second passageway may extend transverse to one another (e.g., at a right angle or a substantially 90 degree angle) and be in communication with one another. The set screw 239 is threadably received along a threaded third passageway of the lug 238. The third passageway extends transverse to the first passageway and the second passageway (e.g., at a right or substantially 90 degree angle to both the first passageway and the second passageway) and is in communication with the first passageway and the second passageway. Thus, the set screw 239 clamps the first loop and the elongated portion of the lanyard 227 within the respective passageways when tightened.

Length adjustment of the adjustable trailer breakaway lanyard assembly 227 is accomplished by partial loosening of the cable clamp set screw 239, such as by using a standard size Allen hex wrench, and then sliding the cable clamp lug assembly 237 along lanyard cable 230 in either direction along the lanyard cable 230 and then re-tightening the cable clamp set screw to fully secure the cable clamp lug assembly 237 to achieve the desired amount of cable slack or general tightness within the trailer breakaway lanyard assembly 227, as it is connected and is then engaged between the tow vehicle bumper 214 and the trailer breakaway cable leading to the trailer breakaway activation switch.

FIG. 8 shows the adjustable length cable lanyard cable clamp 237 including the cable clamp lug 238 having an internal thread 240 for threaded engagement with the cable clamp set screw 239. The cable clamp lug assembly may be preferably formed of stainless steel material or similar alloy materials to help avoid degradation and corrosion caused by exposure to the elements, and in particular to road salt and deicing chemicals commonly used in areas subject to winter driving conditions. The cable clamp assembly lug assembly may be commercially available from Davis Village Solutions LLC of New Ipswich, NH.

Optionally, it is foreseeable that the cable clamp set screw 239 can be readily replaced with a knurled head thumb screw, like the one shown in FIGS. 6 and 6A. In this case, the use of a knurled head thumb screw can eliminate the need for using an Allen hex wrench for the sake of improved user ease and convenience.

In other words, the cable clamp includes an internal hex setscrew that is tightened to secure the lanyard cable at its desired length setting, such as by using a standard hex key or Allen wrench. Optionally, the internal hex set screw may be optionally replaced by a male threaded thumb screw (not shown) of correct thread dimensions and similar length for ease of adjustment by hand without the need for an Allen wrench to make breakaway lanyard length adjustments at the trailer hitch between a tow vehicle and a trailer.

In addition to ease of installation, and ease of length adjustment capability for ease of installation with most vehicle installations, the trailer breakaway lanyard and reminder information tag further provides ease or replacement and serviceability in that it may be easily replaced should this be required for any reason, including for example unexpected or unforeseen loss, theft, damage, or unexpected excess wear or deterioration due to environmental exposure. In addition, one or more spare trailer breakaway lanyards can be easily stored within a tow vehicle, within a toolbox, or even within a trailer itself for ease of replacement and serviceability whenever needed.

Changes and modifications in the specifically described embodiments may be carried out without departing from the principles of the present invention, which is intended to be limited only by the scope of the appended claims as interpreted according to the principles of patent law.

1. A breakaway lanyard for a vehicular trailer hitch assembly, the breakaway lanyard comprising:
a flexible cable comprising (i) a first end having a first loop (ii) a second end opposite the first end and having a second loop and (iii) an elongated portion extending between the first end and the second end;
wherein the flexible cable is configured to wrap around a structural member of a vehicle with the first loop coupling to the elongated portion to attach the breakaway lanyard to the vehicle;
wherein, with the breakaway lanyard attached to the structural member of the vehicle, and with a trailer coupled to a hitch of the vehicle, the second loop is configured to couple to a breakaway cable of the trailer; and
wherein, with the second loop coupled to the breakaway cable of the trailer, movement of the breakaway cable and the second end of the flexible cable away from the structural member of the vehicle causes tension in the flexible cable and the breakaway cable to activate an emergency braking system of the trailer.

2. The breakaway lanyard of claim 1, wherein a warning tag is attached to the flexible cable at or near the second loop.

3. The breakaway lanyard of claim 1, wherein a material of the flexible cable comprises at least one selected from the group consisting of (i) stainless steel, (ii) steel nylon, (iii) Kevlar and (iv) flexible carbon fiber.

4. The breakaway lanyard of claim 1, wherein the flexible cable is coated with a flexible urethane plastic coating.

5. The breakaway lanyard of claim 1, wherein a first crimp secures the first end to the elongated portion of the flexible cable to form the first loop.

6. The breakaway lanyard of claim 1, wherein a second crimp secures the second end to the elongated portion of the flexible cable to form the second loop.

7. The breakaway lanyard of claim 1, wherein the structural member of the vehicle comprises a bumper of the vehicle.

8. The breakaway lanyard of claim 1, wherein the structural member of the vehicle comprises a frame of the vehicle.

9. The breakaway lanyard of claim 1, wherein the first loop couples to the elongated portion by having the elongated portion pass through the first loop.

10. The breakaway lanyard of claim 1, wherein a clamp is disposed at the elongated portion, and wherein the clamp attaches to the first loop to couple the first loop to the elongated portion.

11. The breakaway lanyard of claim 10, wherein, with the breakaway lanyard attached to the structural member of the vehicle, the clamp is movable along the elongated portion to set an available length of the flexible cable between the second loop and the structural member of the vehicle.

12. The breakaway lanyard of claim 10, wherein the clamp comprises a set screw lug and a screw, and wherein the set screw lug includes (i) a first passageway and (ii) a second passageway that extends transverse to the first passageway and is in communication with the first passageway, and wherein, with the breakaway lanyard attached to the structural member of the vehicle, (a) the elongated portion of the flexible cable extends through the first passageway of the set screw lug, (b) the screw is threadably received along the second passageway of the set screw lug, (c) the screw engages the elongated portion of the flexible cable within the first passageway to retain the clamp at the elongated portion, and (d) a hook connects between the first loop and the set screw lug to attach the clamp to the first loop.

13. The breakaway lanyard of claim 10, wherein the clamp comprises a set screw lug and a screw, and wherein the set screw lug includes (i) a first passageway, (ii) a second passageway that extends transverse to the first passageway and (iii) a third passageway that extends transverse to the first passageway and the second passageway and is in communication with the first passageway and the second passageway, and wherein, with the breakaway lanyard attached to the structural member of the vehicle, (a) the elongated portion of the flexible cable extends through the first passageway of the set screw lug, (b) the first loop is received within the second passageway of the set screw lug, (c) the screw is threadably received along the third passageway of the set screw lug, and (d) the screw clamps the elongated portion and the first loop between the screw and the set screw lug to retain the clamp at the elongated portion and to retain the first loop at the clamp.

14. A breakaway lanyard for a vehicular trailer hitch assembly, the breakaway lanyard comprising:
a flexible cable comprising (i) a first end having a first loop (ii) a second end opposite the first end and having a second loop and (iii) an elongated portion extending between the first end and the second end;
wherein a clamp is disposed at the elongated portion, and wherein the clamp comprises a set screw lug and a screw, and wherein the set screw lug includes (i) a first passageway and (ii) a second passageway that extends transverse to the first passageway and is in communication with the first passageway;
wherein the flexible cable is configured to wrap around a structural member of a vehicle with the clamp attaching to the first loop to attach the breakaway lanyard to the vehicle;
wherein, with the breakaway lanyard attached to the structural member of the vehicle, (i) the elongated portion of the flexible cable extends through the first passageway of the set screw lug, (ii) the screw is threadably received along the second passageway of the set screw lug, (iii) the screw engages the elongated portion of the flexible cable within the first passageway to retain the clamp at the elongated portion, and (iv) a hook connects between the first loop and the set screw lug to attach the clamp to the first loop.
wherein, with the breakaway lanyard attached to the structural member of the vehicle, the screw disengages from the elongated portion and the clamp is movable along the elongated portion to set an available length of the flexible cable between the second loop and the structural member of the vehicle;
wherein, with the breakaway lanyard attached to the structural member of the vehicle, and with a trailer coupled to a hitch of the vehicle, the second loop is configured to couple to a breakaway cable of the trailer; and
wherein, with the second loop coupled to the breakaway cable of the trailer, movement of the breakaway cable and the second end of the flexible cable away from the structural member of the vehicle causes tension in the flexible cable and the breakaway cable to activate an emergency braking system of the trailer.

15. The breakaway lanyard of claim 14, wherein a material of the flexible cable comprises at least one selected from the group consisting of (i) stainless steel, (ii) steel nylon, (iii) Kevlar and (iv) flexible carbon fiber.

16. The breakaway lanyard of claim 14, wherein a first crimp secures the first end to the elongated portion of the flexible cable to form the first loop, and wherein a second crimp secures the second end to the elongated portion of the flexible cable to form the second loop.

17. The breakaway lanyard of claim 14, wherein the structural member of the vehicle comprises one selected from the group consisting of (i) a bumper of the vehicle and (ii) a frame of the vehicle.

18. A breakaway lanyard for a vehicular trailer hitch assembly, the breakaway lanyard comprising:
a flexible cable comprising (i) a first end having a first loop (ii) a second end opposite the first end and having a second loop and (iii) an elongated portion extending between the first end and the second end;
wherein a first crimp secures the first end to the elongated portion of the flexible cable to form the first loop;
wherein a second crimp secures the second end to the elongated portion of the flexible cable to form the second loop;
wherein a clamp is disposed at the elongated portion, and wherein the clamp comprises a set screw lug and a screw, and wherein the set screw lug includes (i) a first passageway, (ii) a second passageway that extends transverse to the first passageway and (iii) a third passageway that extends transverse to the first passageway and the second passageway and is in communication with the first passageway and the second passageway;
wherein the flexible cable is configured to wrap around a structural member of a vehicle with the clamp attaching to the first loop to attach the breakaway lanyard to the vehicle;
wherein, with the breakaway lanyard attached to the structural member of the vehicle, (i) the elongated portion of the flexible cable extends through the first passageway of the set screw lug, (ii) the first loop is received within the second passageway of the set screw lug, (iii) the screw is threadably received along the third passageway of the set screw lug, and (iv) the screw clamps the elongated portion and the first loop between the screw and the set screw lug to retain the clamp at the elongated portion and to retain the first loop at the clamp;
wherein, with the breakaway lanyard attached to the structural member of the vehicle, the screw releases the elongated portion and the clamp is movable along the elongated portion to set an available length of the flexible cable between the second loop and the structural member of the vehicle;
wherein, with the breakaway lanyard attached to the structural member of the vehicle, and with a trailer coupled to a hitch of the vehicle, the second loop is configured to couple to a breakaway cable of the trailer; and
wherein, with the second loop coupled to the breakaway cable of the trailer, movement of the breakaway cable and the second end of the flexible cable away from the structural member of the vehicle causes tension in the flexible cable and the breakaway cable to activate an emergency braking system of the trailer.

19. The breakaway lanyard of claim 18, wherein a warning tag is attached to the flexible cable at or near the second loop.

20. The breakaway lanyard of claim 18, wherein a material of the flexible cable comprises at least one selected from the group consisting of (i) stainless steel, (ii) steel nylon, (iii) Kevlar and (iv) flexible carbon fiber.
